(19) United States
(12) Patent Application Publication
(10) Pub. No.: US 2026/0062127 A1
(43) Pub. Date: Mar. 5, 2026

(54) INCLINED HEAD AND NECK SUPPORT FOR PASSENGERS

(71) Applicant: B/E Aerospace, Inc., Winston-Salem, NC (US)

(72) Inventors: Krishna Chaitanya Prathipati, Hyderabad (IN); Swetha Jonnalagadda, Hyderabad (IN)

(21) Appl. No.: 19/311,607

(22) Filed: Aug. 27, 2025

(30) Foreign Application Priority Data
Aug. 27, 2024 (IN) 202411064708

(51) Int. Cl. B64D 11/06

(52) U.S. Cl. CPC B64D 11/0642

(57) ABSTRACT

An adjustable headrest assembly for an aircraft seat with secondary flaps is disclosed. The adjustable headrest assembly may include a base structure configured to attach to a headrest area of an aircraft seat. The base structure may include a base frame with u-shaped brackets on both an upper and a lower side. The base structure may also include two slide guides configured to retain sliding members, with an upper slide guide coupling into the u-shaped brackets on the upper side and a lower slide guide coupling into the u-shaped brackets on the lower side. The sliding members may include a first sliding member and a second sliding member, configured to slide horizontally outwards. The assembly may further include primary flaps, each rotatably coupled to opposing sides of the base structure, and secondary flaps, each rotatably coupled to the primary flaps.

### CROSS-REFERENCE TO RELATED APPLICATIONS

The present application claims the benefit of India Provisional Patent Application 202411064708, filed Aug. 27, 2024, titled INCLINED HEAD AND NECK SUPPORT FOR PASSENGERS, which is incorporated herein by reference in the entirety.

### TECHNICAL FIELD

The present disclosure relates generally to aircraft seats, and, more particularly, to adjustable headrests.

### BACKGROUND

Current adjustable seat headrests typically only have small flaps that can flip to 90 degrees for head support. Even shorter passengers such as teenage kids cannot fully utilize the current flaps due to the headrest movement restriction. Passengers sitting in window seats can lean against the aircraft wall and rest their head up with a pillow. However, this option is only available to passengers in window seats. In order to utilize this option, passengers may twist into an awkward pose that may prevent the passenger from attaining a comfortable position.

Currently, passengers are carrying neck pillows to provide support to their neck.

There is a need for an improved aircraft seat headrest that provides enhanced adjustability and support for passengers' heads and necks in various seating positions.

### SUMMARY

An adjustable headrest assembly for an aircraft seat is disclosed in accordance with one or more illustrative embodiments of the present disclosure. In one illustrative embodiment, the adjustable headrest assembly includes a base structure configured to attach to a headrest area of an aircraft seat. In another illustrative embodiment, the base structure includes a base frame comprising u-shaped brackets on an upper side and a lower side of the base frame. In another illustrative embodiment, the base structure includes two slide guides configured to retain sliding members. In another illustrative embodiment, the two slide guides include an upper slide guide configured to couple into the u-shaped brackets on the upper side of the base frame and a lower slide guide configured to couple into the u-shaped brackets on the lower side of the base frame. In another illustrative embodiment, the sliding members include a first sliding member and a second sliding member, where the first sliding member is configured to simultaneously be retained within a first side of the upper slide guide and the lower slide guide, and the second sliding member is configured to simultaneously be retained within a second side of the upper slide guide and the lower slide guide. In another illustrative embodiment, the sliding members are configured to slide horizontally outwards.

In another illustrative embodiment, the adjustable headrest assembly includes primary flaps comprising a first primary flap and a second primary flap, the primary flaps rotatably coupled to opposing sides of the base structure via a primary set of friction hinges configured to rotate around a primary rotation axis. In another illustrative embodiment, the adjustable headrest assembly includes secondary flaps comprising a first secondary flap rotatably coupled to the first primary flap and a second secondary flap rotatably coupled to the second primary flap, where the secondary flaps are coupled via a secondary set of friction hinges configured to rotate around a secondary rotation axis that is perpendicular to the primary rotation axis.

In a further aspect, the adjustable headrest assembly is configured to support a user's shoulders when the secondary flaps are in a folded down position. In another aspect, when in a folded stowed position, a shape of secondary flap cushions of the secondary flaps is equal to, overlapping with, and aligned with a shape of primary flap cushions of the primary flaps. In another aspect, a base structure cushion coupled to the base frame is twice a thickness of primary flap cushions and secondary flap cushions coupled to the primary flaps and secondary flaps, respectively. In another aspect, the adjustable headrest assembly includes dress cover fabric between primary flaps cushions covers of the primary flaps and a base structure cushion cover of the base structure cushion. In another aspect, the primary flaps are rotatable between 0 to at least 90 degrees relative to the base structure. In another aspect, the secondary flaps are rotatable between 0 to at least 180 degrees relative to the primary flaps. In another aspect, the base structure is configured to enable a horizontal movement of the first primary flap and the second primary flap by at least 3.35 inches. In another aspect, the secondary flaps are configured to provide shoulder support to persons below a height of 5 foot 9 inches when rotated to a second position. In another aspect, the adjustable headrest assembly further includes stops configured to stop a horizontal movement of the first sliding member and the second sliding member by engaging one or more slot ends of slots of the first sliding member and the second sliding member.

An aircraft seat is disclosed in accordance with one or more illustrative embodiments of the present disclosure. In one illustrative embodiment, the aircraft seat includes a seat frame. In another illustrative embodiment, an adjustable headrest assembly is coupled to the seat frame. In another illustrative embodiment, the adjustable headrest assembly includes a base structure configured to attach to a headrest area of an aircraft seat. In another illustrative embodiment, the base structure includes a base frame comprising u-shaped brackets on an upper side and u-shaped brackets on a lower side. In another illustrative embodiment, two slide guides are configured to retain sliding members, including an upper slide guide configured to couple into the u-shaped brackets on the upper side of the base frame and a lower slide guide configured to couple into the u-shaped brackets on the lower side of the base frame. In another illustrative embodiment, the sliding members include a first sliding member and a second sliding member, configured to simultaneously be retained within a first side of the upper slide guide and the lower slide guide, and to slide horizontally outwards. In another illustrative embodiment, primary flaps include a first primary flap and a second primary flap, rotatably coupled to opposing sides of the base structure via a primary set of friction hinges configured to rotate around a primary rotation axis. In another illustrative embodiment, secondary flaps include a first secondary flap rotatably coupled to the first primary flap and a second secondary flap rotatably coupled to the second primary flap, where the secondary flaps are coupled via a secondary set of friction hinges configured to rotate around a secondary rotation axis that is perpendicular to the primary rotation axis.

In a further aspect, the adjustable headrest assembly is configured to support a user's shoulders when the secondary flaps are in a folded down position. In another aspect, when in a folded stowed position, the shape of secondary flap cushions of the secondary flaps is equal to, overlapping with, and aligned with the shape of primary flap cushions of the primary flaps. In another aspect, a base structure cushion coupled to the base frame is twice the thickness of primary flap cushions and secondary flap cushions coupled to the primary flaps and secondary flaps, respectively. In another aspect, the adjustable headrest assembly includes dress cover fabric between primary flaps cushions covers of the primary flaps and a base structure cushion cover of the base structure cushion. In another aspect, the primary flaps are rotatable between 0 to at least 90 degrees relative to the base structure. In another aspect, the secondary flaps are rotatable between 0 to at least 180 degrees relative to the primary flaps. In another aspect, the base structure is configured to enable a horizontal movement of the first primary flap and the second primary flap by at least 3.35 inches. In another aspect, the secondary flaps are configured to provide shoulder support to persons below a height of 5 foot 9 inches when rotated to a second position. In another aspect, the adjustable headrest assembly further includes stops configured to stop a horizontal movement of the first sliding member and the second sliding member by engaging one or more slot ends of slots of the first sliding member and the second sliding member.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims.

FIG. 1A is a front view of an adjustable headrest assembly in a folded stowed position with cushions hidden for clarity, in accordance with one or more embodiments of the present disclosure.

FIG. 1B is a front view of the adjustable headrest assembly with the coupled flaps in an extended horizontal position, in accordance with one or more embodiments of the present disclosure.

FIG. 1C is a front view of the adjustable headrest assembly with the secondary flaps in a folded down position, in accordance with one or more embodiments of the present disclosure.

FIG. 1D is a front view of the adjustable headrest assembly with the primary flaps in a folded inward position, in accordance with one or more embodiments of the present disclosure.

FIG. 2 is a front perspective view of the adjustable headrest assembly, in accordance with one or more embodiments of the present disclosure.

FIG. 3 is a front perspective view of stops, slots, and friction hinges of the adjustable headrest assembly, in accordance with one or more embodiments of the present disclosure.

FIG. 4 is a front perspective view of a support plate of the adjustable headrest assembly, in accordance with one or more embodiments of the present disclosure.

FIG. 5A is a front view of the adjustable headrest assembly with cushions, in accordance with one or more embodiments of the present disclosure.

FIG. 5B is a front view of the adjustable headrest assembly with cushions folded inwards and extended horizontally, in accordance with one or more embodiments of the present disclosure.

FIG. 6 is a front view of the adjustable headrest assembly with dress cover fabric, in accordance with one or more embodiments of the present disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

Broadly speaking, embodiments of the concepts disclosed herein are directed to an adjustable headrest assembly for aircraft seats that provides enhanced support and comfort for passengers, including secondary flaps that fold down and a slide out functionality. In one or more embodiments, the adjustable headrest assembly includes a base structure configured to attach to the headrest area of an aircraft seat, primary flaps rotatably coupled to the base structure, and secondary flaps rotatably coupled to the primary flaps. The assembly allows for both horizontal and vertical adjustments to accommodate passengers of different sizes and seating preferences. In embodiments, the primary and secondary flaps can be rotated and extended to provide customized head, neck, and shoulder support. For example, the horizontal sliding members allow for accommodating passengers with broad necks and the secondary flaps may aide in supporting shorter passengers or shoulders of passengers. This design enables passengers to adjust the headrest for optimal comfort in various seating positions. Further, the assembly may include cushions of varying thicknesses, such as half thicknesses of the flap cushions to compactly fold inwards in a stowed position. This approach provides a flexible and adaptable headrest solution that significantly improves passenger comfort on long flights while meeting aircraft safety requirements in a compact design.

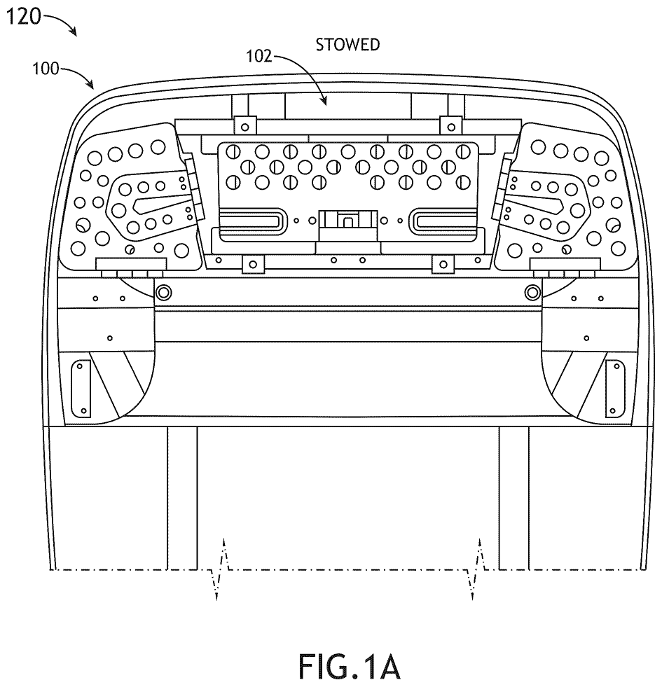

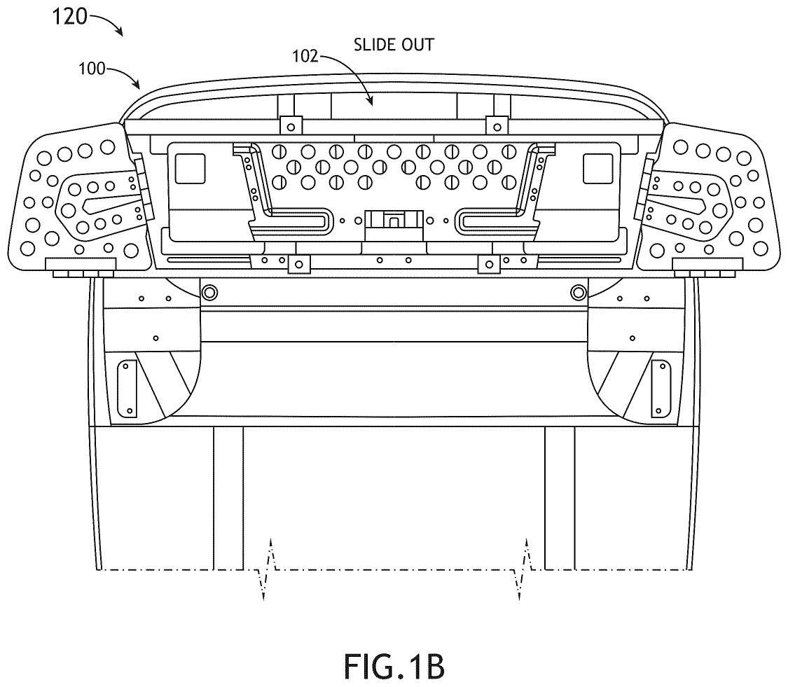

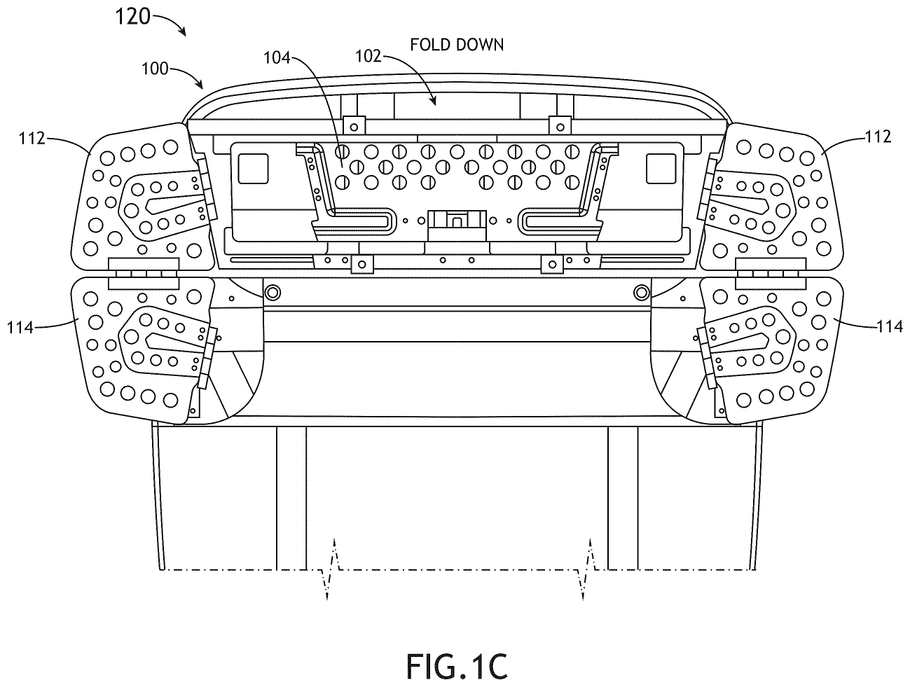

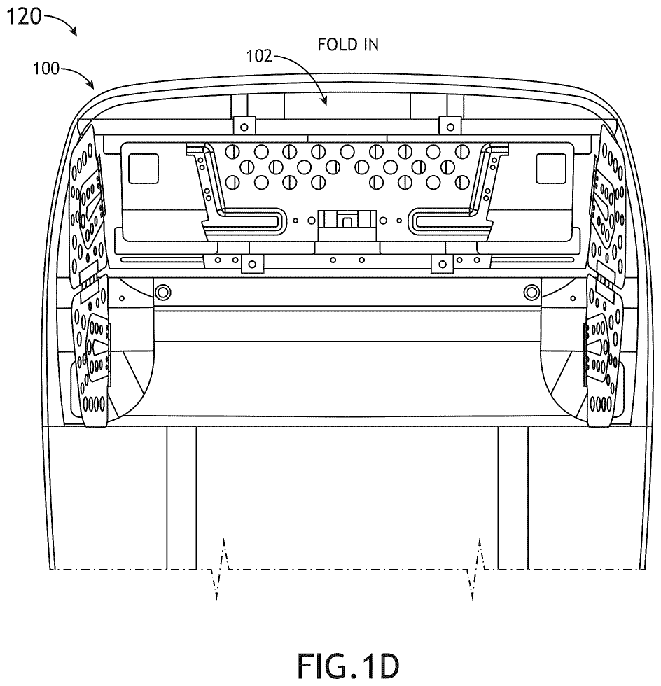

FIGS. 1A-1D show views of an adjustable headrest assembly 100 in various positions/configurations, in accordance with one or more embodiments of the present disclosure. FIG. 1A illustrates a front view of an adjustable headrest assembly 100 in a folded stowed position with cushions hidden for clarity, in accordance with one or more embodiments of the present disclosure. FIG. 1B illustrates a front view of the adjustable headrest assembly 100 with the coupled flaps in an extended horizontal position, in accordance with one or more embodiments of the present disclosure. FIG. 1C illustrates a front view of the adjustable headrest assembly 100 with the secondary flaps 114 in a folded down position, in accordance with one or more embodiments of the present disclosure. FIG. 1D illustrates a front view of the adjustable headrest assembly 100 with the primary flaps 112 in a folded inward position, in accordance with one or more embodiments of the present disclosure.

In embodiments, the adjustable headrest assembly 100 includes a base structure 102. The base structure 102 may be configured to attach to a headrest area of an aircraft seat, such as being configured to screw into a top portion of a backrest frame of an aircraft seat using fasteners 204 (e.g., screws) or the like. The base structure 102 may include a base frame 104. The base frame 104 may be rectangular and flat in shape.

In embodiments, the adjustable headrest assembly 100 includes primary flaps 112 and secondary flaps 114.

As shown in FIG. 1A, when in a folded stowed position, a shape of secondary flap cushions of the secondary flaps 114 may be equal to, overlapping with, and aligned with a shape of primary flap cushions of the primary flaps 112. This may allow the design to be compact when stowed.

As shown in FIG. 1B-1D, in embodiments, the base structure 102 is configured to enable a horizontal movement of the primary flaps 112. This may help accommodate users with broad necks.

As shown in FIG. 1C-1D, the adjustable headrest assembly 100 may be configured to provide lowered support when the secondary flaps 114 are in a folded down position.

While the secondary flaps 114 are in the folded down position, the primary and secondary flaps 112, 114 may still be able to rotate around vertical axis hinges. This may allow the flaps 112, 114 to fold inwards, as shown in FIG. 1D. In this way, the secondary flaps 114 may provide a wide range of configurations to accommodate a wider variety of passenger body types and their comfort preferences.

For example, a shorter passenger such as a child or teenager may benefit from the secondary flaps 114 by being able to rest their head on the secondary flaps 114.

Furthermore, the secondary flaps 114 may be configured to provide shoulder support when rotated to a second position (i.e., the folded down position of FIGS. 1C and 1D). For example, the position of the secondary flaps 114 when folded down may be low enough, and therefore configured to, provide support to shoulders of persons below the height of 5 foot 9 inches. For instance, the bottom edge of the secondary flaps 114 measured from the top of the seat (pan) may be a maximum distance of 20 inches or less. For instance, the bottom edge of the secondary flaps 114 measured from the top of the seat may be a maximum distance of 18 inches or less. For instance, the bottom edge of the secondary flaps 114 measured from the top of the seat may be a maximum distance of 16 inches or less.

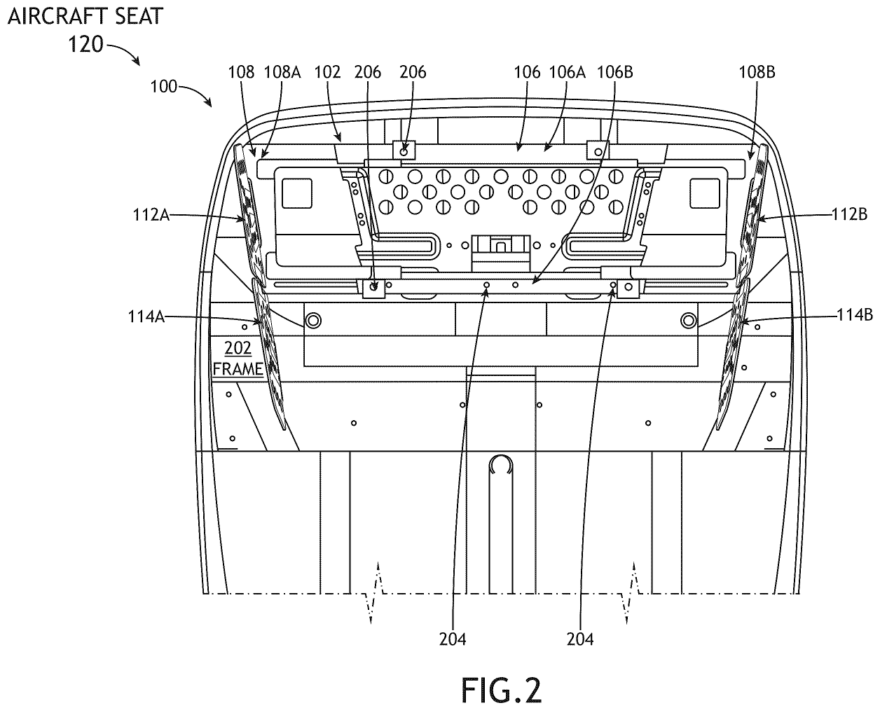

FIG. 2 illustrates a front perspective view of the adjustable headrest assembly 100, in accordance with one or more embodiments of the present disclosure.

In embodiments, an aircraft seat 120 may include the adjustable headrest assembly 100. For example, the aircraft seat 120 may include an aircraft seat frame 202 coupled to the base frame 104 of the adjustable headrest assembly 100.

The base frame 104 may include u-shaped brackets 206 on an upper side (first side) of the base frame 104 and u-shaped brackets 206 on a lower side (second side) of the base frame 104.

The base structure 102 may include two slide guides 106 configured to retain sliding members 108. The two slide guides 106 may include an upper slide guide 106A configured to couple into the u-shaped brackets 206 on the upper side of the base frame 104 and a lower slide guide 106B configured to couple into the u-shaped brackets 206 on the lower side of the base frame 104. The slide guides 106 may include channels of consistent cross-sectional area along the full length of the slide guides 106.

The sliding members 108 may include a first sliding member 108A and a second sliding member 108B. The first sliding member 108A may be shaped such that there is a vertical member and two members extending outwards from the same side of the vertical member when viewed facing the front of the seat 120). The first sliding member 108A may be configured to simultaneously be retained within a first side (e.g., left side) of the upper slide guide 106A and the same first side (e.g., left side) of the lower slide guide 106B. For instance, the two distal ends of the u-shape may each be configured to slide into respective distal ends of channels of the two slide guides 106.

The second sliding member 108B may be shaped such that there is a vertical member and two members extending outwards from the same side of the vertical member, (when viewed facing the front of the seat 120), but in a reverse direction/orientation. The second sliding member may be configured to simultaneously be retained within a second side (e.g., right side) of both the upper slide guide 106A and the lower slide guide 106B.

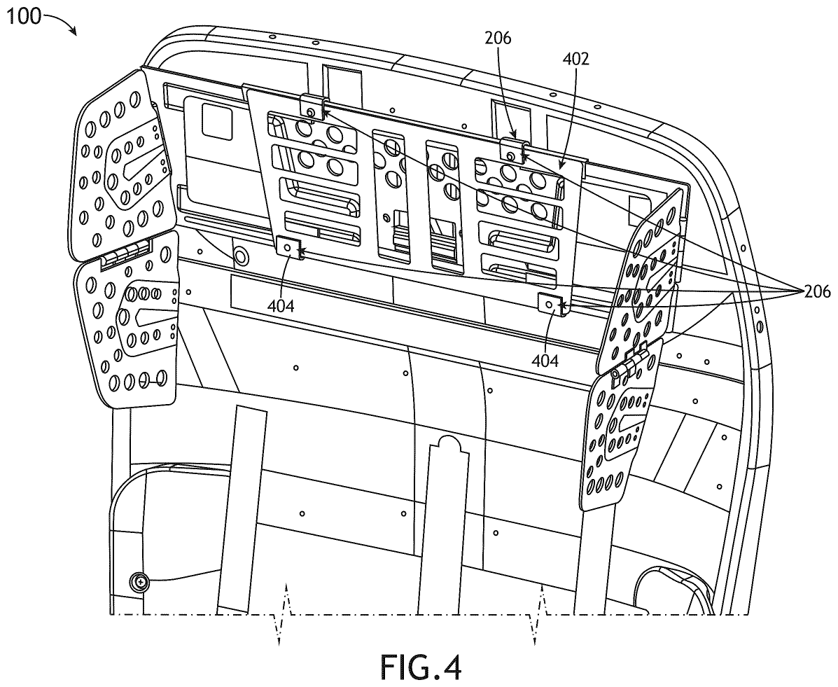

The first side may be opposite relative to the second side, such as horizontally opposite sides. The sliding members 108 may be configured to slide (horizontally) outwards, while the slide guides 106 remain static. For example, the base structure 102 may be configured to enable a horizontal movement of the first primary flap 112A and the second primary flap 112B by at least 3.35 inches. For instance, as shown in FIG. 4, slots 306 and stops 304 may be used, wherein the horizontal length of the slots 306 determine the horizontal sliding distance of each set of flaps.

The secondary flaps 114 may be directly coupled to hinges that are directly coupled to the sliding members 108.

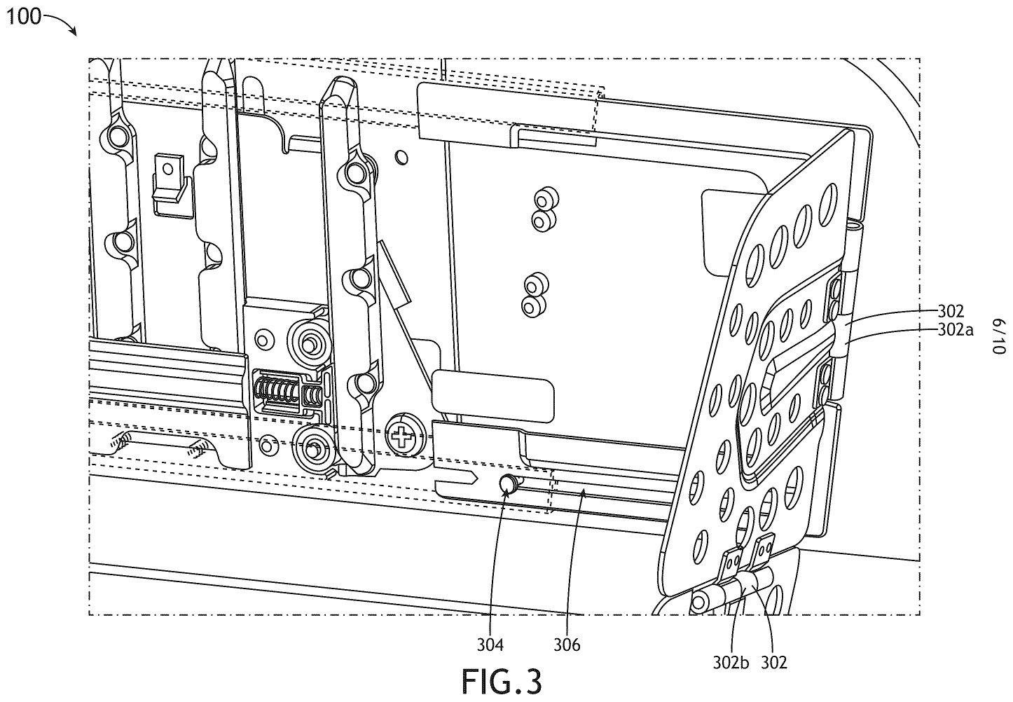

As noted earlier, the adjustable headrest assembly 100 may include primary flaps 112. The primary flaps 112 may include a first primary flap 112A and a second primary flap 112B. The primary flaps 112 may be rotatably coupled to (horizontally) opposing sides of the base structure 102 via hinges 302, such as a primary set of friction hinges 302a (see FIG. 3) configured to rotate around a primary rotation axis.

The adjustable headrest assembly 100 may include secondary flaps 114. The secondary flaps 114 may include a first secondary flap 114A rotatably coupled to the first primary flap 112A and a second secondary flap 114B rotatably coupled to the second primary flap 112B. The secondary flaps 114 may be coupled via a secondary set of friction hinges 302b (see FIG. 3) configured to rotate around a secondary rotation axis that is perpendicular to the primary rotation axis.

FIG. 3 illustrates a front perspective view of stops, slots, and friction hinges of the adjustable headrest assembly 100, in accordance with one or more embodiments of the present disclosure.

The adjustable headrest assembly 100 may include stops 304 configured to stop a horizontal movement of the first sliding member 108A and the second sliding member 108B by engaging one or more slot ends of slots 306 of the first sliding member 108A and the second sliding member 108B. For example, the stops 304 may include (or be) fasteners, such as threaded screws or bolts.

The primary flaps 112 may be rotatable between 0 to at least 90 degrees relative to the base structure 102. For example, 0 degrees may refer to coplanar, such as in FIG. 1A, and 90 degrees may be perpendicular to a seat back of the aircraft seat 120. For example, passengers, when they wish to rest, may choose an angle near 90 degrees (perpendicular).

The secondary flaps 114 may be rotatable between 0 to at least 180 degrees relative to the primary flaps 112.

FIG. 4 is a front perspective view of a support plate 402 of the adjustable headrest assembly 100, in accordance with one or more embodiments of the present disclosure.

In embodiments, the adjustable headrest assembly 100 may include a support plate 402. For example, the support plate 402 may be a disposed over the base frame 104 and the slide guides 106. For instance, the support plate 402 may be configured to also fit inside the u-shaped brackets 206 of the base frame 104.

The support plate 402 may provide additional structural support for the horizontal sliding functionality.

The support plate 402 and the slide guides 106 may be fixed in positions via u-shaped bracket fasteners 404 configured to be received by the u-shaped brackets 206 of the base frame 104. For instance, the u-shaped bracket fasteners 404 may be screws, bolts, or the like.

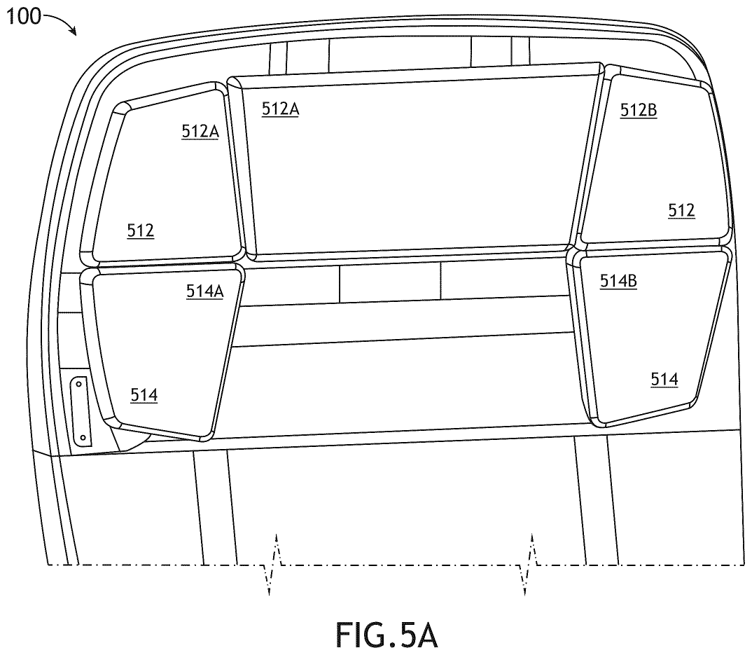

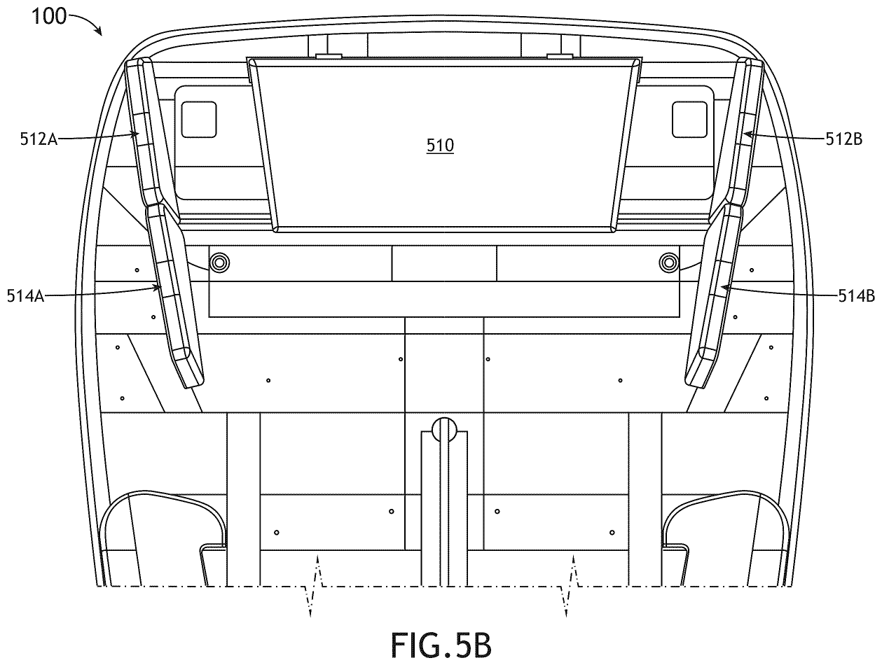

FIG. 5A illustrates a front view of the adjustable headrest assembly 100 with cushions, in accordance with one or more embodiments of the present disclosure.

In embodiments, although hidden in some figures, the adjustable headrest assembly 100 may include cushions.

For example, the adjustable headrest assembly 100 may include a base structure cushion 510 coupled to the base frame 104.

For example, the adjustable headrest assembly 100 may include primary flap cushions 512 and secondary flap cushions 514 coupled to the primary flaps 112 and secondary flaps 114, respectively. Specifically, the adjustable headrest assembly 100 may include a first primary flap cushion 512A and a second primary flap cushion 512B, as well as a first secondary flap cushion 514A and a second secondary flap cushion 514B.

In embodiments, the base structure cushion 510 may be twice a thickness of the primary flap cushions 512 and secondary flap cushions 514. For instance, when the first secondary flap cushion 514A is folded and in a stowed position on top of the first primary flap cushion 512A, their combined thickness may be the same or less than the thickness of the base structure cushion 510. In this way, when in the folded stowed positions of FIG. 1A, outer surfaces of the primary and secondary cushions 512, 514, and the base structure cushion 510 may be coplanar and aligned.

For purposes of the present disclosure, “outer surface” means the surface that is not folded in on itself and may be user-facing, such as a front-facing surface of the aircraft seat 120. Note that the outer surface of the secondary cushions 514 will change sides when the secondary cushions 514 are folded up or down. Also note that the secondary cushions may be dual-sided, such as having the secondary flap 114 (plate) inserted midway into the secondary cushion 514 so that the secondary cushion 514 has cushion material on each side. Also note that such a configuration is merely an example embodiment for illustrative purposes and any configuration may be used.

FIG. 5B illustrates a front view of the adjustable headrest assembly 100 with cushions folded inwards and extended horizontally, in accordance with one or more embodiments of the present disclosure.

The position in FIG. 5B may be referred to as a folded inwards position, or the like.

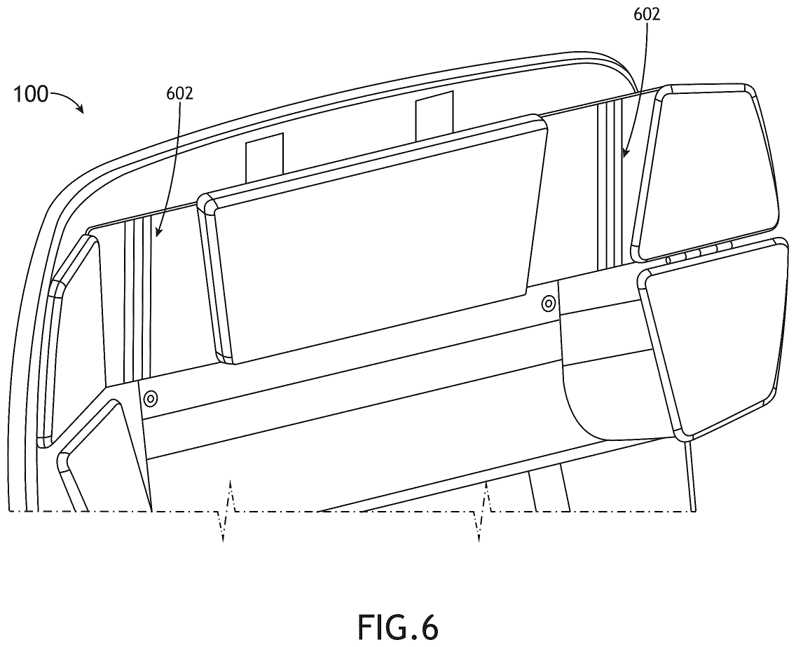

FIG. 6 illustrates a front view of the adjustable headrest assembly 100 with dress cover fabric 602, in accordance with one or more embodiments of the present disclosure.

The adjustable headrest assembly 100 may include dress cover fabric 602 between the primary flap cushions 512 and the base structure cushion 510. The dress cover fabric 602 may be stitched and be configured to have slack in the stowed position of FIG. 1A and no slack in the extended (horizontally position of FIG. 1D). For example, the dress cover fabric 602 may be stitched between each primary flap cushions cover (i.e., fabric covering the primary flap cushions 512) and a base structure cushion cover (i.e., fabric covering the base structure cushion 510).

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “in embodiments”, “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed:

1. An adjustable headrest assembly for an aircraft seat, the adjustable headrest assembly comprising:
a base structure configured to attach to a headrest area of an aircraft seat, wherein the base structure comprises:
a base frame comprising u-shaped brackets on an upper side of the base frame and u-shaped brackets on a lower side of the base frame; and
two slide guides configured to retain sliding members,
wherein the two slide guides comprise:
an upper slide guide configured to couple into the u-shaped brackets on the upper side of the base frame; and
a lower slide guide configured to couple into the u-shaped brackets on the lower side of the base frame;
wherein the sliding members comprise a first sliding member and a second sliding member, wherein the first sliding member is configured to simultaneously be retained within a first side of the upper slide guide and the lower slide guide, wherein the second sliding member is configured to simultaneously be retained within a second side of the upper slide guide and the lower slide guide, wherein the first side is opposite relative to the second side; wherein the sliding members are configured to slide horizontally outwards;
primary flaps comprising a first primary flap and a second primary flap, the primary flaps rotatably coupled to opposing sides of the base structure via a primary set of friction hinges configured to rotate around a primary rotation axis; and
secondary flaps comprising:
a first secondary flap rotatably coupled to the first primary flap; and
a second secondary flap rotatably coupled to the second primary flap,
wherein the secondary flaps are coupled via a secondary set of friction hinges configured to rotate around a secondary rotation axis that is perpendicular to the primary rotation axis.

2. The adjustable headrest assembly of claim 1, wherein the adjustable headrest assembly is configured to support a user's shoulders when the secondary flaps are in a folded down position.

3. The adjustable headrest assembly of claim 1, when in a folded stowed position, a shape of secondary flap cushions of the secondary flaps is equal to, overlapping with, and aligned with a shape of primary flap cushions of the primary flaps.

4. The adjustable headrest assembly of claim 1, wherein a base structure cushion coupled to the base frame is twice a thickness of primary flap cushions and secondary flap cushions coupled to the primary flaps and secondary flaps, respectively.

5. The adjustable headrest assembly of claim 4, wherein the adjustable headrest assembly comprises dress cover fabric between primary flaps cushions covers of the primary flaps and a base structure cushion cover of the base structure cushion.

6. The adjustable headrest assembly of claim 1, wherein the primary flaps are rotatable between 0 to at least 90 degrees relative to the base structure.

7. The adjustable headrest assembly of claim 1, wherein the secondary flaps are rotatable between 0 to at least 180 degrees relative to the primary flaps.

8. The adjustable headrest assembly of claim 1, wherein the base structure is configured to enable a horizontal movement of the first primary flap and the second primary flap by at least 3.35 inches.

9. The adjustable headrest assembly of claim 1, wherein the secondary flaps are configured to provide shoulder support to users having a height of less than 5 foot 9 inches when rotated to a second position.

10. The adjustable headrest assembly of claim 1, wherein the adjustable headrest assembly further comprises stops configured to stop a horizontal movement of the first sliding member and the second sliding member by engaging one or more slot ends of slots of the first sliding member and the second sliding member.

11. An aircraft seat comprising:
a seat frame; and
an adjustable headrest assembly coupled to the seat frame and comprising:
a base structure configured to attach to a headrest area of an aircraft seat, wherein the base structure comprises:
a base frame comprising u-shaped brackets on an upper side of the base frame and u-shaped brackets on a lower side of the base frame; and
two slide guides configured to retain sliding members, wherein the two slide guides comprise:
an upper slide guide configured to couple into the u-shaped brackets on the upper side of the base frame; and
a lower slide guide configured to couple into the u-shaped brackets on the lower side of the base frame;
wherein the sliding members comprise a first sliding member and a second sliding member, wherein the first sliding member configured to simultaneously be retained within a first side of the upper slide guide and the lower slide guide, wherein the second sliding member is configured to simultaneously be retained within a second side of the upper slide guide and the lower slide guide, wherein the first side is opposite relative to the second side; wherein the sliding members are configured to slide horizontally outwards;
primary flaps comprising a first primary flap and a second primary flap, the primary flaps rotatably coupled to opposing sides of the base structure via a primary set of friction hinges configured to rotate around a primary rotation axis; and
secondary flaps comprising:
a first secondary flap rotatably coupled to the first primary flap; and
a second secondary flap rotatably coupled to the second primary flap,
wherein the secondary flaps are coupled via a secondary set of friction hinges configured to rotate around a secondary rotation axis that is perpendicular to the primary rotation axis.

12. The aircraft seat of claim 11, wherein the adjustable headrest assembly is configured to support a user's shoulders when the secondary flaps are in an folded down position.

13. The aircraft seat of claim 11, when in a folded stowed position, a shape of secondary flap cushions of the secondary flaps is equal to, overlapping with, and aligned with a shape of primary flap cushions of the primary flaps.

14. The aircraft seat of claim 11, wherein a base structure cushion coupled to base frame is twice a thickness of primary flap cushions and secondary flap cushions coupled to the primary flaps and secondary flaps, respectively.

15. The aircraft seat of claim 14, wherein the adjustable headrest assembly comprises dress cover fabric between primary flaps cushions covers of the primary flaps and a base structure cushion cover of the base structure cushion.

16. The aircraft seat of claim 11, wherein the primary flaps are rotatable between 0 to at least 90 degrees relative to the base structure.

17. The aircraft seat of claim 11, wherein the secondary flaps are rotatable between 0 to at least 180 degrees relative to the primary flaps.

18. The aircraft seat of claim 11, wherein the base structure is configured to enable a horizontal movement of the first primary flap and the second primary flap by at least 3.35 inches.

19. The aircraft seat of claim 11, wherein the secondary flaps are configured to provide shoulder support to users having a height of less than 5 foot 9 inches when rotated to a second position.

20. The aircraft seat of claim 11, wherein the adjustable headrest assembly further comprises stops configured to stop a horizontal movement of the first sliding member and the second sliding member by engaging one or more slot ends of slots of the first sliding member and the second sliding member.
